(19) United States
(12) Patent Application Publication
(10) Pub. No.: US 2024/0406154 A1
(43) Pub. Date: Dec. 5, 2024

(54) NATIVE LINK ENCRYPTION

(71) Applicant: NVIDIA Corporation, Santa Clara, CA (US)

(72) Inventors: Miriam Menes, Tel Aviv (IL); Naveen Cherukuri, San Jose, CA (US); Ahmad Atamli, Oxford (GB); Uria Basher, Nehusha (IL); Mike Osborn, Hollis, NH (US); Mark Hummel, Franklin, MA (US); Liron Mula, Hertzlia (IL)

(21) Appl. No.: 18/528,603

(22) Filed: Dec. 4, 2023

(30) Foreign Application Priority Data
Jun. 1, 2023 (IL) 303396

(51) Int. Cl. H04L 9/40

(52) U.S. Cl. CPC H04L 63/0457

(57) ABSTRACT

Technologies for encrypting communication links between devices are described. A method includes generating a first initialization vector (IV), from a first subspace of IVs, for a first cryptographic ordered flow, and a second IV, from a second subspace of IVs that are mutually exclusive from the first subspace. The first and second cryptographic ordered flows share a key to secure multipath routing in a fabric between devices. The method sends, to the second device, a first packet for the first cryptographic ordered flow and a second packet for the second cryptographic ordered flow. The first packet includes a first security tag with the first IV and a first payload encrypted using the first IV and a first key. The second packet includes a second security tag with the second IV and a second payload encrypted using the second IV and a second key.

### TECHNICAL FIELD

At least one embodiment pertains to processing resources used to perform and facilitate link communications. For example, at least one embodiment pertains to encrypting multiple links across a network fabric between the devices.

### BACKGROUND

Security is a major concern when moving data, including sensitive information, in a data center (also referred to as a datacenter). The data center can have multiple hardware resources, including multiple processing units such as central processing units (CPUs), graphics processing units (GPUs), network interface cards (NICs), data processing units (CPUs), and the like. When moving data between processing units on communication links, the data may need to be encrypted. The number of paths between devices increases when the processing units are connected to a network fabric network.

### BRIEF DESCRIPTION OF THE SEVERAL VIEWS OF THE DRAWINGS

Various embodiments in accordance with the present disclosure will be described with reference to the drawings, in which:

FIG. 1A is a block diagram of a link encryption system according to at least one embodiment.

FIG. 1B is a block diagram of two cryptographic ordered flows that share a same key over a network between two GPUs according to at least one embodiment.

FIG. 2 illustrates an encrypted packet format according to at least one embodiment.

FIG. 3 illustrates an example local route header (LRH) of a packet according to at least one embodiment.

FIG. 4 illustrates an example native local route header (NVLRH) of a packet according to at least one embodiment.

FIG. 5 is a block diagram of a GPU with two transmit pipelines according to at least one embodiment.

FIG. 6 is a block diagram of a transmit pipeline 600 according to at least one embodiment.

FIG. 7 illustrates three databases for encrypting packets for different cryptographic ordered flows according to at least one embodiment.

FIG. 8 illustrates an example crypto-state entry, an example key entry, and an example flow map entry according to various embodiments.

FIG. 9 is a block diagram of a receive pipeline 900 according to at least one embodiment.

FIG. 10 illustrates three databases for decrypting packets for different cryptographic ordered flows according to at least one embodiment.

FIG. 11 illustrates an example crypto-state entry, an example key entry, and an example replay state entry according to various embodiments.

FIG. 12 illustrates a method 1200 in accordance with one embodiment.

FIG. 13 is a block diagram of link encryption and decryption over multiple paths of a network fabric between a first device and a second device according to at least one embodiment.

### DETAILED DESCRIPTION

Technologies for encrypting communication links between devices are described. As described above, devices connected with a network fabric can have multiple paths between two devices. It is challenging to encrypt a large number of links over a network fabric between a large number of devices.

Aspects and embodiments of the present disclosure address these and other challenges by using multiple cryptographic ordered flows to handle multipath routing in a network fabric, each cryptographic flow defining an independent security association (SA). The independent SA can be verified independently. Aspects and embodiments of the present disclosure address these and other challenges by splitting the SA for each cryptographic ordered flow into source and destination components to make the implementation easier and to ensure different initialization vectors (IVs) for different packets while allowing a shared key on multiple links. Aspects and embodiments of the present disclosure address these and other challenges by splitting mapslots into a primary table and a secondary table to improve an overall security of managing these structures.

Described herein is a high-performance load/store transport layer (referred to as NVLink) that can operate on top of physical and data link layers, such as the InfiniBand (IB) physical and datalink layers. The transport layer can encapsulate a new header (NVLRH) inside an IB LRH header, as described herein. In general, the network routing and fabric protection services can be provided by the IB mechanisms and managed by a subnet management (SM) unit or a subnet management agent (SMA). GPU associations, address-to-target mapping, and multicast group creation services can be managed by a Global Fabric Manager (GFM) or Local Fabric Manager (LFM). An in-line compute engine (ICE) or crypto engine (CPE) can be configured for confidential computing and can support end-to-end encryption and decryption for multiple cryptographic ordered flows that share a key to secure multipath routing in a fabric between a first device (e.g., a first GPU) and a second device (e.g., a second GPU). The key can initialization vectors (IVs) generated for the cryptographic ordered flows can be generated from a first subspace of IVs. The IVs for a first cryptographic ordered flow are mutually exclusive from the IVs for the second cryptographic ordered flow. The following description provides a hardware architecture with an encryption scheme for NVLink over IB. The following description specifies a packet format, replay checks, deletion checks, reordering checks, key generation schemes, and IV generation schemes.

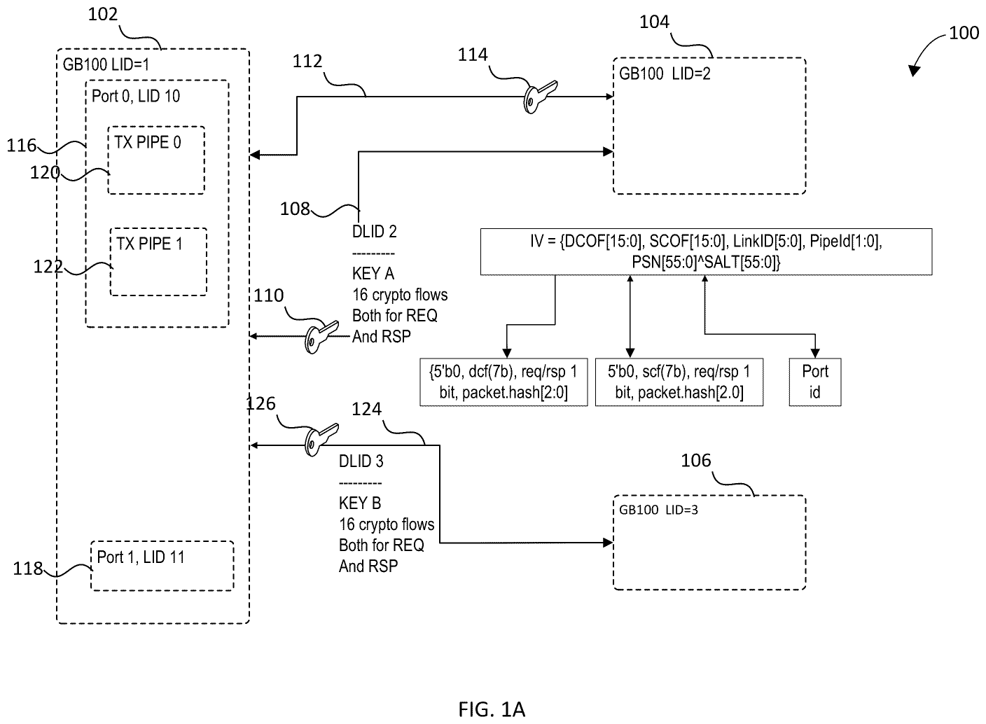

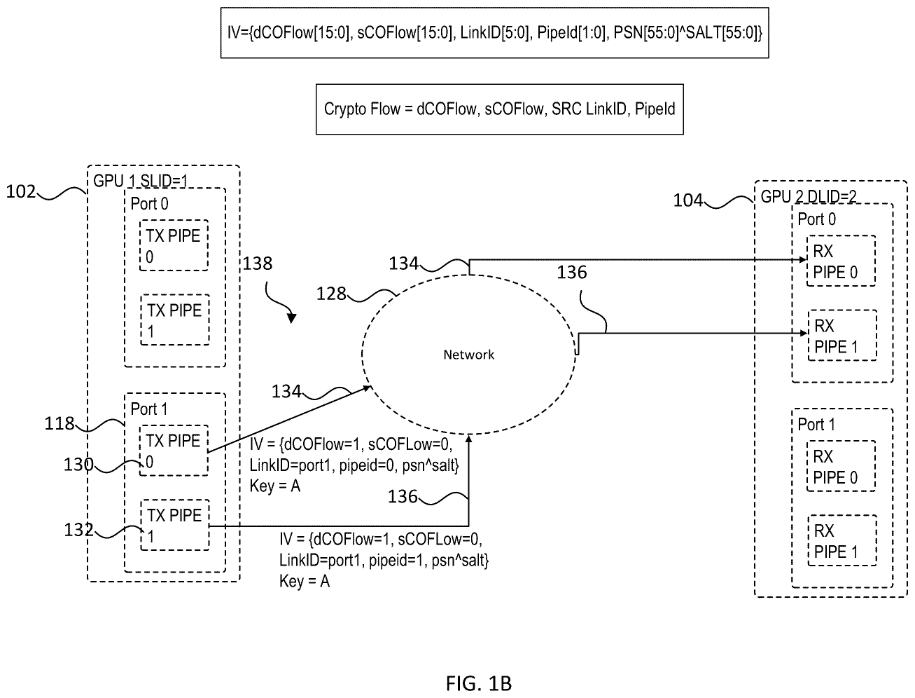

FIG. 1A is a block diagram of a link encryption system 100 according to at least one embodiment. The link encryption system 100 is being described with respect to encrypting multiple cryptographic flows between multiple GPUs, including a first GPU 102, a second GPU 104, and a third GPU 106. For example, the link encryption system 100 can include 128 GPUs interconnected via a fabric network, with approximately 2000 cryptographic ordered flows in the link encryption system 100. The link encryption system 100 can use 128 keys for transmit (Tx) and 256 keys for receive (Rx). The link encryption system 100 provides end-to-end (GPU-to-GPU) encryption. The link encryption system 100 can be used in connection with GPU confidential computing in a GPU hardware trusted execution environment (TEE) for accelerated confidential computing. The link encryption system 100 provides data confidentiality and data integrity. The data confidentiality ensures that other entities cannot read the data. The data integrity ensures that data modifications by other entities can be detected.

As illustrated in FIG. 1A, between each GPU source (SRC) and GPU destination (DST), there is a single cryptographic flow (single key) containing multiple (e.g., 16) cryptographic ordered flows. The cryptographic flow can use a single key, and each cryptographic ordered flow can be a routing hash that uniquely identifies an individual path or route between the GPU SRC and GPU DST. As illustrated, the first GPU 102 establishes a first cryptographic flow 108 with the second GPU 104. The first cryptographic flow 108 includes 16 cryptographic ordered flows for both a request (REQ) path and a response (RSP) path in a first direction from the first GPU 102 to the second GPU 104. A second cryptographic flow 112 includes 16 cryptographic ordered flows for both a REQ path and an RSP path in a second direction from the second GPU 104 to the first GPU 102. Instead of using separate keys (e.g., 16 keys) for each of the 16 cryptographic ordered flows, the first GPU 102 uses a first shared key 110 (single key) for the first cryptographic flow 108 and a routing hash that uniquely identifies one of the 16 cryptographic ordered flow. The first GPU 102 uses a second shared key 114 (single key) for the second cryptographic flow 112 and a routing rash that uniquely identifies one of the 16 cryptographic ordered flows. The routing hash can be encoded as multiple bits (e.g., 3 bits) in a request packet or a response packet to uniquely the path/route for the respective cryptographic ordered flow. The first GPU 102 uses a single key per path (e.g., GPU SRC→GPU DST), and the single key is shared over the 16 cryptographic ordered flows using the routing hash. As such, the first GPU 102 uses the first shared key 110 for all 16 paths but reduces the space of IVs with some of the bits of the IV as denoted in the routing hash. There is mutual exclusivity between the IVs for the different cryptographic ordered flows. A different prefix (e.g., hash 3 bits, Req/Rsp packet) can be used to distinguish between the IVs for the different cryptographic ordered flows. The same IV cannot be used with the same key twice. The first GPU 102 and the second GPU 104 use the same first shared key 110 for communications in the first direction (REQ/RSP is with respect to the first direction). The first GPU 102 and the second GPU 104 can use the same second shared key 114 for communications in the second direction (REQ/RSP is with respect to the second direction). The second shared key 114 can be shared among the 16 cryptographic ordered flows from the second GPU 104 to the first GPU 102. When communicating with a third GPU 106, the first GPU 102 can use a third shared key 126 for communication in a third cryptographic flow 124 in a first direction (REQ/RSP). The third shared key 126 can be shared among the 16 cryptographic ordered flows from the first GPU 102 to the second third GPU 106.

Each cryptographic flow (also referred to as a crypto connection) between two GPUs per direction is denoted using a source cryptographic flow identifier or index (SCF) and a destination cryptographic flow identifier or index (DCF). The cryptographic ordered flow of a cryptographic flow can be denoted using a source cryptographic ordered flow (SCOF), and a destination cryptographic ordered flow (DCOF). The SCF (SCOF) can point to the key in the source device, and the DCF (DCOF) can point to the key in the destination device. The SCOF and DCOF can be expressed in the following equations (1) and (2), respectively:

$$SRC crypto ordered flow ( S C O F ) = \qquad ( 1 )$$

$$\{ {5}^{′} b 0 , SCF ( {7}^{′} b ) , req / rsp ( 1 bit ) , packet . N V L R H . {hash}_{-} {2}_{-} 0 [ 2 : 0 ] \} // \text{} for 2 K flows$$

$$DST crypto ordered flow ( D C O F ) = \qquad ( 2 )$$

$$\{ {5}^{′} b 0 , DCF ( 7 b ) , req / rsp ( 1 bit ) , packet . N V L R H . {hash}_{-} {2}_{-} 0 [ 2 : 0 ] \} // \text{} for 2 K flows$$

For approximately two thousand cryptographic ordered flows, for example, the SCOF uses the SCF, a request or response bit that indicates whether the packet is a request packet or a response packet, and a routing hash (e.g., 3 bits). The DCOF uses the DCF, a request or response bit, and a routing hash. It should be noted that the embodiments described herein can be used with different numbers of cryptographic ordered flows. Also, as described above, the same IV cannot be used with the same key twice, so the IV as a different prefix is used for each flow as expressed in the following equation (3):

$$I V = d C O F l o w [ 15 : 0 ] sCOFLow [ 15 : 0 ] , LinkID [ 5 : 0 ] , P i p e I d [ 1 : 0 ] , P S {N [ 55 : 0 ]}^{\hat{}} S A L T [ 55 : 0 ] \qquad ( 3 )$$

It should be noted that, in some embodiments, strict ordering per each cryptographic ordered flow should be kept in the link encryption system 100. As such, a packet number (e.g., a packet sequential number (PSN) can be used as part of the SCOF, DCOF, and IV. The packet number (or PSN) should increase without any jumps to maintain strict ordering within a cryptographic ordered flow. The IV includes the DCOF, SCOF, a link identifier (LinkId), a pipeline identifier, a PSN, and a cryptographic salt. The link identifier can be an egress port number. In other embodiments, a security association can be defined by portions of the IV, including the DCOF, SCOF, LinkID, and PipeID, whereas the PSN and cryptographic salt can be considered a cryptographic state (or crypto-state) that is separate from the security association. The security association of a cryptographic ordered flow can be defined as the DCOF, SCOF, LinkId (hash function), and PipeID. The cryptographic state can be calculated by performing an exclusive-or (XOR) operation on a packet sequence number and a cryptographic salt. The cryptographic salt can be a set of random bits. The IV can be made up of the security association and the cryptographic state. It should be noted that, in other embodiments, the IV separation mechanism can be used if each ordered flow is not “strictly” ordered, but rather “loosely” ordered. The flow may be “loosely” ordered in that most of the packets are in ordered, but if one or more packets are out of order, the system can continue to operate using various out-of-order mechanisms. For strict ordering enforcement, if the last accepted packet sequence number is X, then the next acceptable packet sequency number is X+1. For other loose ordering enforcements, other approaches can be used, such as a monotonously increasing approach (e.g., as in some MACSec cases) or a window-based approach (as in some IPsec cases). For the monotonously increasing approach, if the last accepted packet sequence number is X, then the next acceptable packet sequence number is in a range of [X+1, X+2 . . . . X+window]. For the window based approach, if the last accepted packet sequence number is X, then the next acceptable packet sequence number is any non already accepted sequence number in the range of [X−window . . . X+window]. This does not limit the use of the PSN as part of the IV. Also, it should be noted that “strict” and “loose” ordering are referring to the ordering at a receiver. At the sender, the ordering must be strict, but reordering may occur in the network for some implementations.

Referring back to FIG. 1A, the first GPU 102 can include multiple egress ports, for example, a first egress port 116 and a second egress port 118. Each egress port can include multiple transmit (TX) pipelines for generating and encrypting packets for transmission. The first egress port 116 includes a first transmit pipeline 120 and a second transmit pipeline 122. The IV can uniquely identify which egress port and transmit pipeline are used for a packet.

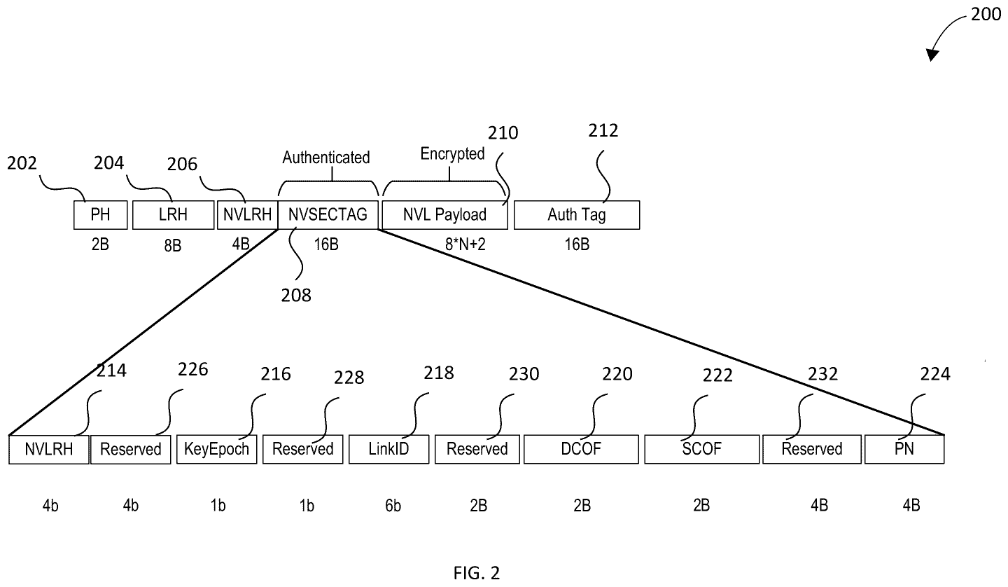

In at least one embodiment, the first GPU 102 generates a first IV, from a first subspace of IVs, for a first cryptographic ordered flow of the multiple cryptographic ordered flows that share the first shared key 110 to secure multipath routing in a network fabric (also referred to as a fabric) between the first GPU 102 and the second GPU 104. The 8 subspaces, SS0 . . . SS7, can be set by the hash function (e.g., subspace [i]=(Hash_2_0==i)). The first GPU 102 generates and sends, to the second GPU 104, a first packet for the first cryptographic ordered flow. The first packet includes a first security tag with the first IV and a first payload encrypted using the first IV and a first key. The first key can be derived from the first shared key 110. The first GPU 102 generates a second IV, from a second subspace of IVs, for a second cryptographic ordered flow of the multiple cryptographic ordered flows that share the first shared key 110. The first IV and the second IV are different. The second subspace of IVs is mutually exclusive from the first subspace. The first GPU 102 generates and sends, to the second GPU 104, a second packet for the second cryptographic ordered flow. The second packet includes a second security tag with the second IV and a second payload encrypted using the second IV and a second key. The second key can be derived from the first shared key 110. For example, the encryption function of the first GPU 102 stores a sequence number (e.g., psn[55:0]) per key in a subspace (e.g., {key, subspace}). For each encrypted packet of subspace [i], the sequence number is increased by 1 (e.g., psn[i] is increased by 1) such that if packet[1] and packet[2] belong to the same subspace (i.e., ordered flow), their IVs differ by the sequence number field (e.g., psn field). If packet[1] and packet[2] belong to different subspaces (i.e., different ordered flows), they differ at least by the hash field (e.g., hash_2_0 field). An example packet format is illustrated and described below with respect to FIG. 2.

In at least one embodiment, the first IV defines a first security association, including i) a first security association (SA) index associated with the first GPU 102 (SCOF), ii) a second SA index associated with the second GPU 104 (DCOF), iii) a first path identifier of a first path of the multipath routing in the fabric between the first GPU 102 and the second GPU 104 (e.g., hash function associated with the route), and iv) a first packet number (PN) associated with the first cryptographic ordered flow. The second IV defines a second security association, including i) a third SA index associated with the first GPU 102, ii) a fourth SA index associated with the second GPU 104, iii) a second identifier of the second cryptographic ordered flow (e.g., hash function associated with route), and iv) a second PN associated with the second cryptographic ordered flow.

FIG. 1B is a block diagram of two cryptographic ordered flows that share a same key over a network between two GPUs according to at least one embodiment. The first GPU 102 and second GPU 104 are coupled to a network 128. The network 128 can be a switched fabric or a switching fabric. The first GPU 102 includes the second egress port 118 with a first transmit pipeline 130 and a second transmit pipeline 132. The first GPU 102 can communicate with the second GPU 104 in a first direction using a cryptographic connection 138 that includes multiple cryptographic ordered flows, including a first cryptographic ordered flow 134 and a second cryptographic ordered flow 136. The cryptographic connection 138 uses the first shared key 110 across the multiple cryptographic ordered flows. The first transmit pipeline 130 can encrypt packets sent in a first cryptographic ordered flow 134. The first cryptographic ordered flow 134 can have a first security association defined by DCOF, SCOF, SRC LinkID, and PipeID. The SRC LinkId can identify the first GPU 102 (or the second egress port 118), and the PipeId can identify the first transmit pipeline 130. The second transmit pipeline 132 can encrypt packets sent in a second cryptographic ordered flow 136. The second cryptographic ordered flow 136 can have a second security associated defined by DCOF, SCOF, SRC LinkID, and PipeID.

The first transmit pipeline 130 can generate a first IV when generating and sending packets. The first transmit pipeline 130 can encrypt the packets using the first IV and the first shared key 110. The first transmit pipeline 130 can include an encryption block cipher, such as AES-GCM 128 or 256 bits, to encrypt the packets using the first shared key 110 and the first IV. The first IV can be incremented using a PSN for each packet in a sequence of packets. The first IV can be defined as follows in equation (4):

$${IV}_{1} = \{ dCOFlow = 1 , sCOFlow = 0 , LinkID = port 1 , pipeid = 0 , psn \hat{} salt \} \qquad ( 4 )$$

The second transmit pipeline 132 can generate a second IV when generating and sending packets. The second transmit pipeline 132 can encrypt the packets using the second IV and the first shared key 110. The second transmit pipeline 132 can include an encryption block cipher to encrypt the packets using the first shared key 110 and the second IV. The second IV can be incremented using a PSN for each packet in a sequence of packets. The second IV can be defined as follows in equation (5):

$${IV}_{2} = \{ dCOFlow = 1 , sCOFlow = 0 , LinkID = port 1 , pipeid = 1 , psn \hat{} salt \} \qquad ( 5 )$$

The packets can be encrypted end-to-end (GPU-to-GPU or GPU-to-NIC) according to an encrypted packet format, illustrated and described below with respect to FIG. 2.

FIG. 2 illustrates an encrypted packet format 200 according to at least one embodiment. The encrypted packet format 200 includes a packet header 202, a local route header (LRH) 204, a native local route header (NVLRH) 206, a security tag header 208, an encrypted payload 210, and an authentication tag 212. The authentication tag 212 can include sixteen bytes (16B). The security tag header 208 includes a version field 214, a key epoch field 216, a LinkID field 218, a DCOF field 220, a SCOF field 222, a PN field 224, and reserved fields 226, 228, 230, and 232. The version field 214 can include version information and can be four bits, for example. The version field 214 can store a zero initially. The key epoch field 216 can be a single bit and store a 1-bit key index used for key rotation. The LinkID field 218 can store a link identifier. The link identifier can identify an egress port number. The DCOF field 220 can store a DCOF. The DCOF can include 6 bits to identify the DCOF (index to SA (DST GPU). The SCOF field 222 can store a SCOF. The SCOF can include 6 bits to identify the SCOF (index to SA (SRC GPU)). The PN field 224 can store a 32-bit value. The 32 bits can be the low bits of a packet number. The packet number can be a PSN.

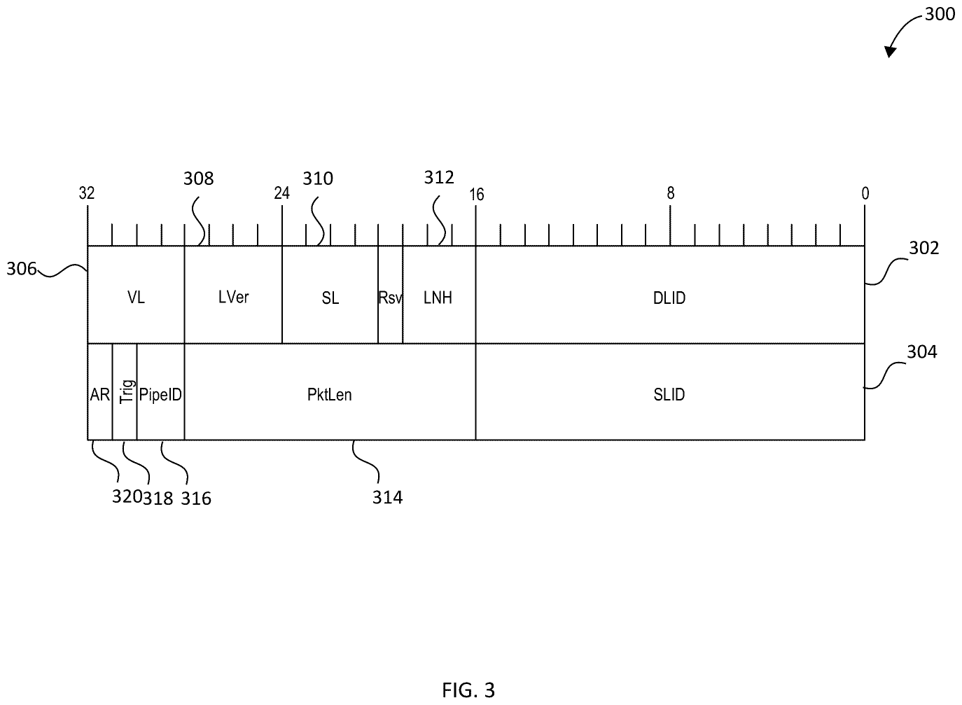

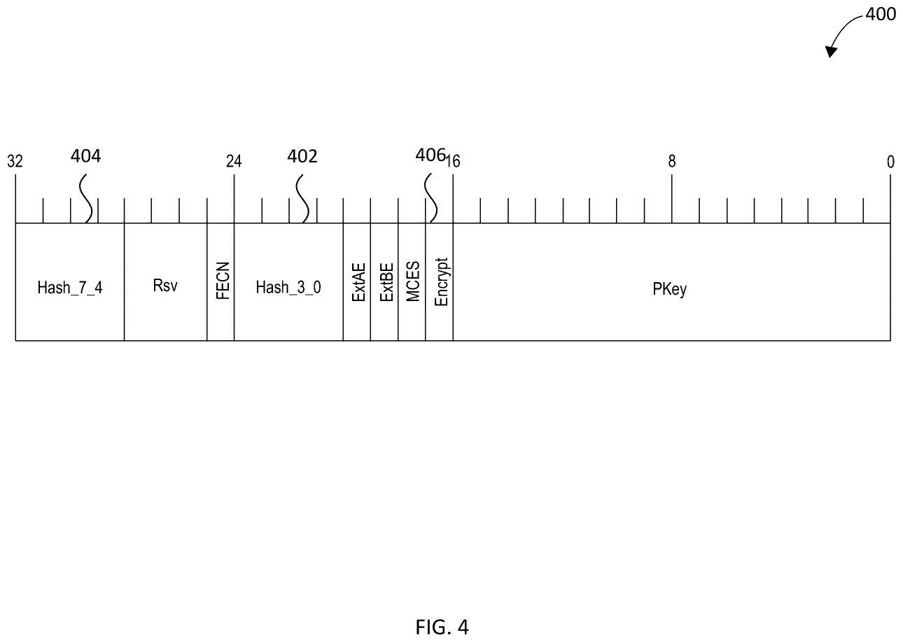

In at least one embodiment, the security tag header 208 can be authenticated, while the local route header 204 and native local route header 206 are not authenticated. The security tag header 208 can include the reserved bits from the reserved fields 226, 228, 230, and 232. The encrypted payload 210 can be encrypted using the shared key and the IV, as described herein. Additional details of the LRH 204 and the NVLRH 206 are described below with respect to FIG. 3 and FIG. 4, respectively.

FIG. 3 illustrates an example local route header (LRH) 300 of a packet according to at least one embodiment. The LRH 300 can be the local route header 204 of FIG. 2. The LRH 300 includes various fields for a destination link identifier (DLID) 302, a source link identifier (SLID) 304, a virtual lane (VL) 306, a link version (LVer) 308, a service level (SL) 310, a next header (LNH) 312, a packet length (Pkt len) 314, a pipeline identifier (PipeID) 316, a trigger (TRIG) 318, and an adaptive routing (AR) enable 320. Adaptive Routing is a forwarding scheme, commonly used in the InfiniBand® protocol), that allows forwarding engines (e.g., routers, bridges) to choose a path of multiple paths on a packet basis, rather than on a flow basis. In at least one embodiment, the DLID 302 is a destination media access control (MAC) address of a destination device, and the SLID 304 is a source MAC address of a source device. The VL 306 can be an index to a receiver buffer associated with the virtual lane. The VL 306 can be a function of a service level (SL), and the SL can be fixed per cryptographic ordered flow. The LVer 308 can specify a version of the InfiniBand version for the transport layer. The SL 310 can be created in the sender and fixed during the route. The LNH 312 can identify the NVLRH 206. The Pkt len 314 can indicate a length of the packet, including the LRH up to a stop in 4-byte granularity. The PipeID 316 can specify a GPU source PipeId or a GPU destination PipeId. The TRIG 318 can be used for debugging features. The AR enable 320 can be used for auto repeat features.

FIG. 4 illustrates an example native local route header (NVLRH) 400 of a packet according to at least one embodiment. The NVLRH 400 can be the native local route header 206 of FIG. 2. The NVLRH 400 includes various fields, including one or more hash fields 402, 404, to store bits of a routing hash as described herein. An encrypt field 406 can specify that the next header is the security tag header 208. The NVLRH 400 can include other fields.

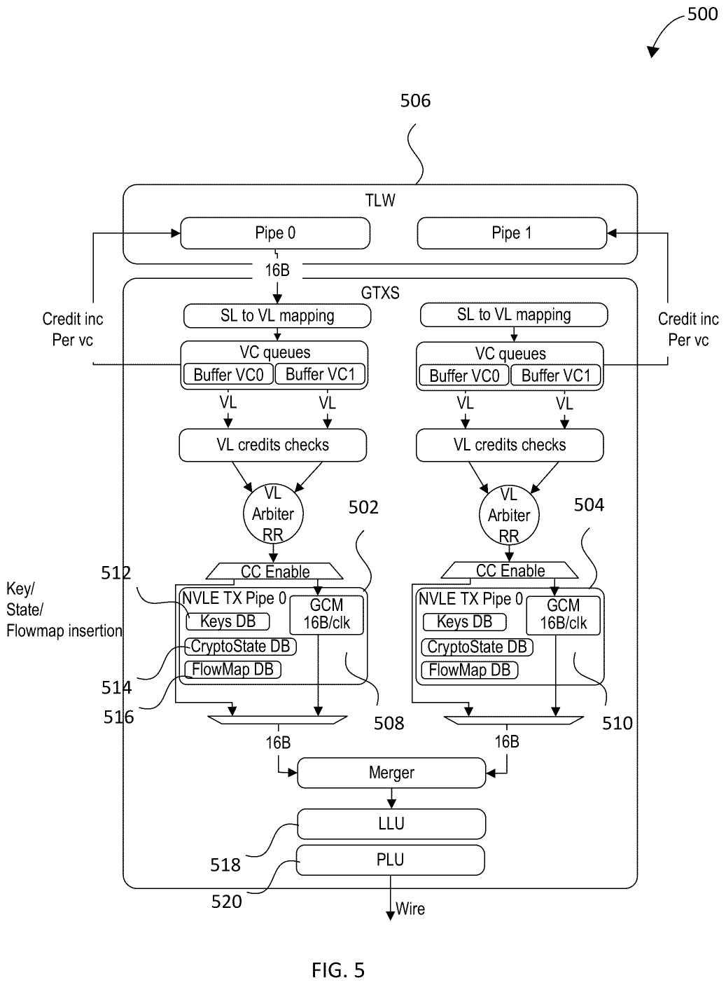

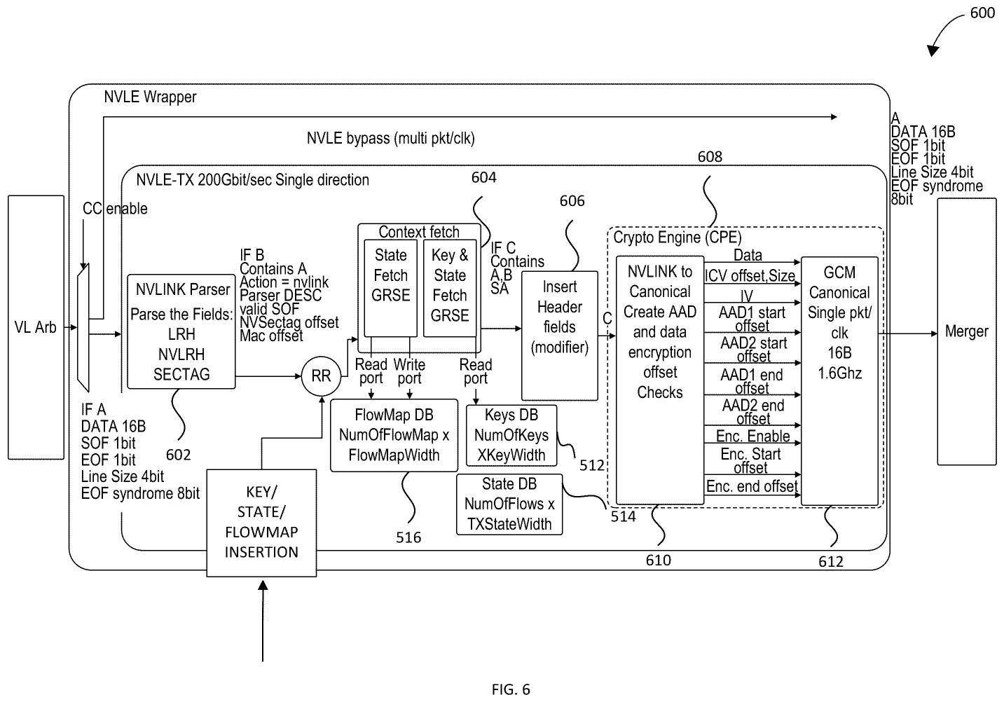

FIG. 5 is a block diagram of a GPU 500 with two transmit pipelines according to at least one embodiment. The GPU 500 can be the first GPU 102, the second GPU 104, or the third GPU 106 of FIG. 1A. The GPU 500 can include a transport layer wrapper (TLW) 506 that separates data to be processed by two data paths, each including a transmit pipeline. The first data path includes some logic for mapping the service level to the virtual lanes and arbitrating data fed into a first transmit pipeline 502. The first transmit pipeline 502 includes an encryption block cipher 508, a key database 512, a crypto-state database 514, and a flowmap database 516. The key database 512, the crypto-state database 514, and the flowmap database 516 can provide a key and an IV to the encryption block cipher 508 to encrypt the packet (or a portion of a packet). The second transmit pipeline 504 includes similar components to encrypt the packet (or a portion of a packet) using the encryption block cipher 510. The outputs of the first transmit pipeline 502 and first transmit pipeline 502 can be merged before being processed by a link layer unit (LLU) 518 and a physical layer unit (PLU) 520 before being sent over the physical medium (e.g., wire(s)). On the transmit side, the encryption block (e.g., encryption block cipher 508) is located after the VL arbitration. It should be noted that different VLs should not be associated with the same order cryptographic flow (REQ/RSP pkts). Additional details of the first transmit pipeline 502 and the second transmit pipeline 504 are described below with respect to FIG. 6.

FIG. 6 is a block diagram of a transmit pipeline 600 according to at least one embodiment. The transmit pipeline 600 can be the first transmit pipeline 502 or the second transmit pipeline 504 of FIG. 5. The transmit pipeline 600 can include parser logic 602, a context fetch logic 604, header insertion logic 606, and a crypto engine (CPE) 608. The CPE 608 can be the encryption block cipher 508 or the encryption block cipher 510 of FIG. 5. The CPE 608 can include conversion logic 610 and a GCM block 612.

During operation, the first transmit pipeline 502 can parse fields corresponding to the LRH, VLRH, and SECTAG using the parser logic 602. The context fetch logic 604 can fetch a state from the flowmap database 516, a key from the key database 512, and a crypto-state from the crypto-state database 514. The first transmit pipeline 600 can insert header fields into the packet using the header insertion logic 606 before being passed to the CPE 608. On the transmit side, the header insertion logic 606 can add the security tag and a placeholder for the authentication tag (e.g., zeros). The LRH packet length can be updated by the transmit pipeline 600. The conversion logic 610 can convert the NVLink information to canonical for processing by the GCM block 612. The GCM block 612 can be a single packet, single clock engine (canonical). The conversion logic 610 can create additional authentication data (ADD) and data encryption offsets for the CPE 608. The data, IV, ADD, etc., can be passed to the GCM block 612 to encrypt the payload.

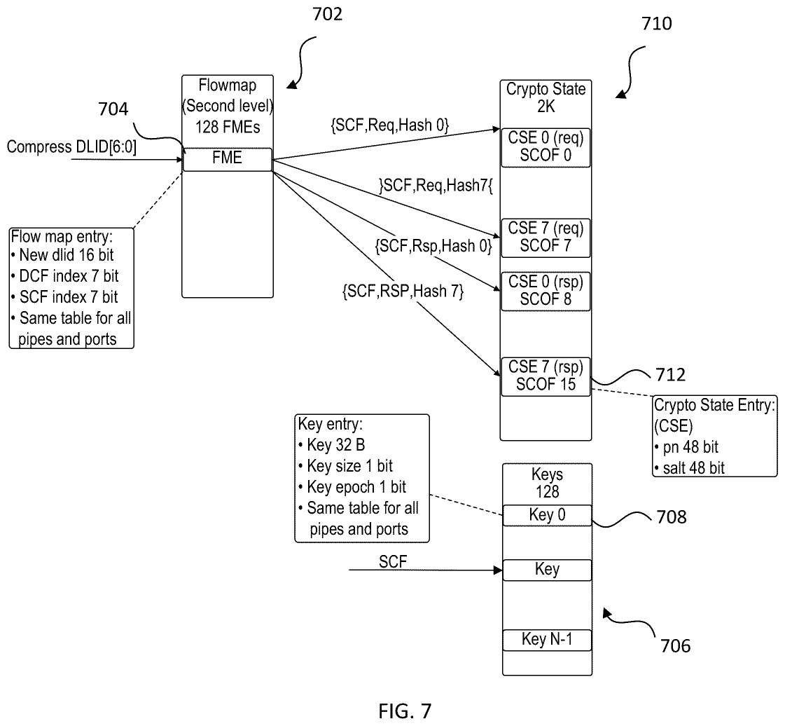

In at least one embodiment, the transmit pipeline 600 can operate at 1.6 GHz and supports 200 Gbit/sec bi-directional per GPU slice. The transmit pipeline 600 supports end-to-end encryption. The number of security associations (SAs) per GPU pipeline can be 2K end-to-end with 2K state entries, 128 keys for transmit operations. A receiver pipeline can have 2K state entries and 256 keys for receive operations. The GCM block 612 can operate on 16 B at 1.6 GHz. The GCM block 612 can operate on either 128 bits or 256 bits. The GCM block 612 can also generate an authentication tag (e.g., 16 B). Additional details of the context fetch logic 604 retrieving the keys and states from the flowmap database 516, key database 512, and 514, as described in more detail below with respect to FIG. 7.

FIG. 7 illustrates three databases for encrypting packets for different cryptographic ordered flows according to at least one embodiment. A flowmap database 702 includes multiple flow map entries (FMEs), such as FME 704. Each FME includes a DLID (e.g., 16 bits), a DCF index (also referred to as DCOF) (e.g., 7 bits), and an SCF index (e.g., 7 bits). The flowmap database 702 can be used for all GPU pipelines and TX ports. A compressed DLID can index the FMEs (e.g., 7 bits). In some cases, the DLID, DCOF, and SCOF can be used for request packets. The size of the flowmap database 702 can be the number of FMEs times a flowmap width.

A key database 706 includes multiple key entries, such as key entry 708. Each key entry includes a key (e.g., 32B), a key size (e.g., 1 bit), and a key epoch (e.g., 1 bit). The key database 706 can be used for all GPU pipelines and TX ports. The SCF index can index the key entries (e.g., 7 bits). The size of the key database 706 can be the number of key entries times a key width.

A crypto-state database 710 includes multiple crypto-state entries (CSEs), such as crypto-state entry 712. Each crypto-state entry includes a packet number and a cryptographic salt. SCF, Req/Res, and a routing hash value can index the crypto-state entries. The size of the crypto-state database 710 can be the number of crypto-state entries times a crypto-state width. As described above, a different prefix (e.g., hash 3 bits, Req/Rsp packet) can be used to distinguish between the IVs for the different cryptographic ordered flows. A first cryptographic flow can have an entry for a request path and a response path. In at least one embodiment, the crypto-state entries for the request paths can be stored in a first portion of the crypto-state database 710, and the crypto-state entries for the response paths can be stored in a second portion of the crypto-state database 710. In at least one embodiment, the routing hash is three bits, resulting in eight crypto-state entries for eight request paths and eight crypto-state entries for the corresponding eight response paths. The flowmap database 702, key database 706, and key entry 708 allow a single key to be used for different paths/routes between source and destination devices while providing unique security associations for each cryptographic ordered flow.

In at least one embodiment, the flowmap database 702, key database 706, and crypto-state database 710 can operate with the following parameters: i) a number of flows is approximately 1K; ii) a number of keys for transmit (Tx keys) is equal to the number of flows divided by 16; iii) the number of flow map entries is equal to the number of flows divided by 16; iv) the flow map width can be equal to Log 2 of the number of flow map entries (e.g., 28 bits); v) crypto-state width is equal to 96 bits; vi) key width is equal to 32 B.

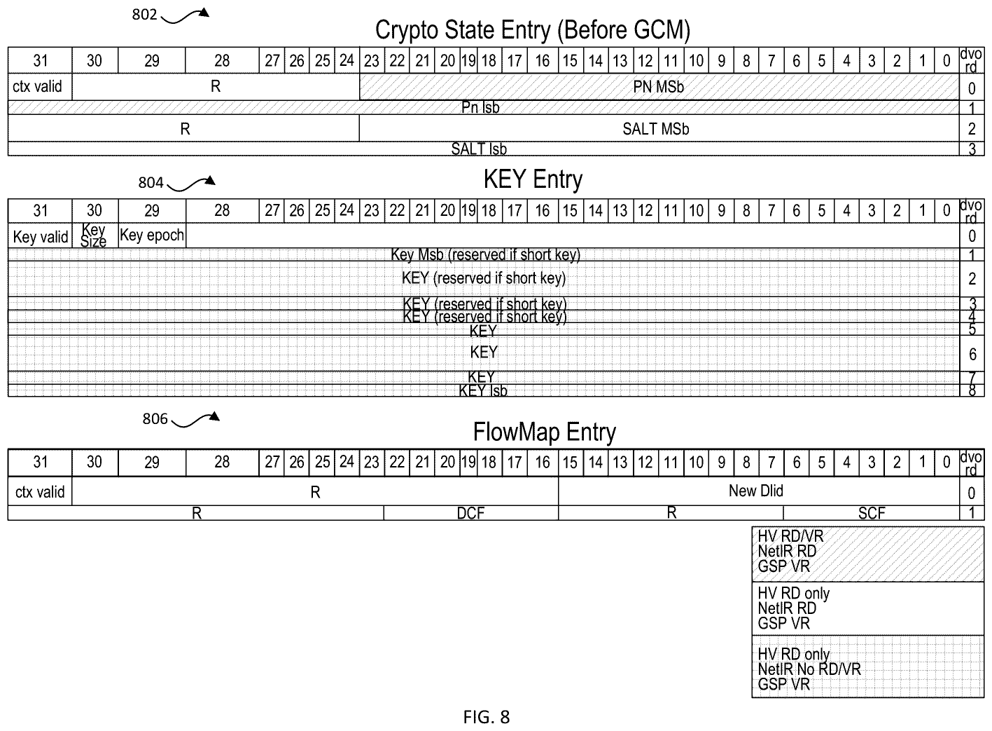

FIG. 8 illustrates an example crypto-state entry 802, an example key entry 804, and an example flow map entry 806 according to various embodiments. As illustrated in FIG. 8, the crypto-state entry 802 includes a packet number and a cryptographic salt. The key entry 804 includes a key valid bit (or valid key bit), a key size bit, a key epoch bit, and a key. As described above, the flow map entry 806 includes a DLID, DCF, and SCF. In at least one embodiment, the SCOF is a pointer used to identify the crypto-state entry 802 (e.g., PTR=SCOF), and the SCF is a pointer used to identify the key entry 804 (e.g., PTR=SCF). The SCF can be stored in the flow map entry 806. The state entry number is based on a routing hash and req/rsp bit (e.g., State Entry Num=Num of Flows (#GPUx HashX Req/RSP)). The key entry number is the number of flows divided by sixteen (e.g., Key entry Num=Num of Flows/16)

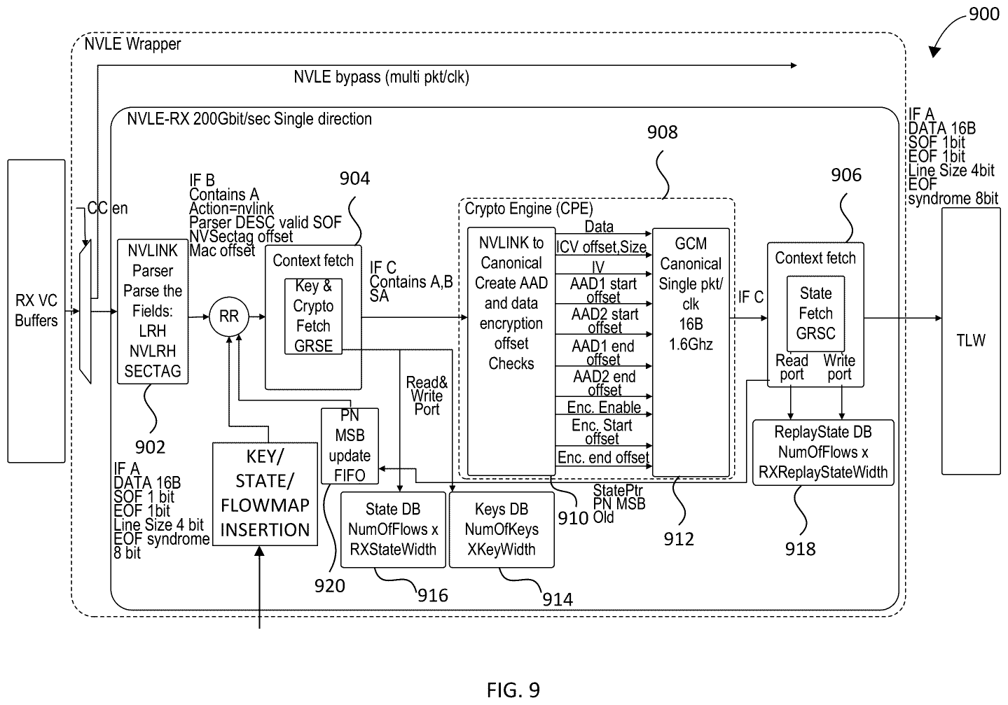

FIG. 9 is a block diagram of a receive pipeline 900 according to at least one embodiment. The receive pipeline 900 can be any of the receive pipelines of the second GPU 104 of FIG. 2. The receive pipeline 900 can include parser logic 902, a context fetch logic 904, and a CPE 908. The CPE 908 can be a decryption block cipher. The CPE 908 can include conversion logic 910 and a GCM block 912.

During operation, the receive pipeline 900 can parse fields corresponding to the LRH, VLRH, and SECTAG using the parser logic 902. The context fetch logic 904 can fetch a key from the key database 914 and a crypto-state from the crypto-state database 916. The conversion logic 910 can convert the NVLink information to a canonical format for processing by the GCM block 912. The GCM block 612 can be a single packet, single clock engine. The conversion logic 910 can create additional authentication data (ADD) and data encryption offsets for the CPE 908. The data, IV, ADD, etc., can be passed to the GCM block 912 to decrypt the payload.

In at least one embodiment, the receive pipeline 900 can include additional context fetch logic 906 to fetch a replay state from a replay state database 918. The additional context fetch logic 906 and replay state database 918 can be used to prevent replay attacks. Once decrypted, the PN can be fed back and added to a first-in-first-out (FIFO) 920.

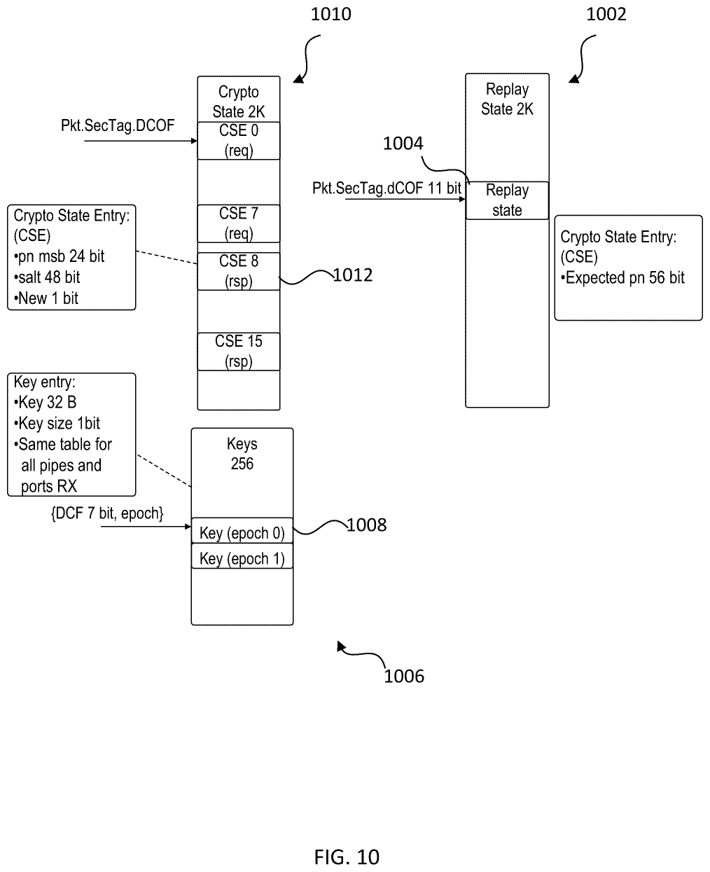

FIG. 10 illustrates three databases for decrypting packets for different cryptographic ordered flows according to at least one embodiment. A replay state database 1002 includes multiple replay state entries, such as replay state entry 1004. Each replay state entry includes an expected packet number (e.g., 56 bits). The replay state entries can be indexed by a DCOF from a security tag of a packet (e.g., 11 bits). In some cases, the DLID, DCOF, and SCOF can be used for request packets. The size of the replay state database 1002 can be the number of replay state entries times a replay state width.

A key database 1006 includes multiple key entries, such as key entry 1008. Each key entry includes a key (e.g., 32B), a key size (e.g., 1 bit), and a key epoch (e.g., 1 bit). The key database 1006 can be used for all GPU pipelines and all RX ports. The key entries can be indexed by the DCF index (e.g., 7 bits) and the epoch bit. The size of the key database 1006 can be the number of key entries times a key width.

A crypto-state database 1010 includes multiple crypto-state entries (CSEs), such as crypto-state entry 1012. Each crypto-state entry includes a packet number and a cryptographic salt. The crypto-state entry can also include a PN recovery bit (labeled New Bit). The PN recovery bit is the highest accepted PN at the bit location on a PN circle (e.g., Pn=0, Pn=2\hat{ }30, and Pn=2\hat{ }31, Pn=0). The crypto-state entries can be indexed by DCF and a req/rsp bit from a security tag of a packet. The size of the crypto-state database 1010 can be the number of crypto-state entries times a crypto-state width. As described above, a different prefix (e.g., hash 3 bits, Req/Rsp packet) can be used to distinguish between the IVs for the different cryptographic ordered flows. A first cryptographic flow can have an entry for a request path and a response path. In at least one embodiment, the crypto-state entries for the request paths can be stored in a first portion of the crypto-state database 1010, and the crypto-state entries for the response paths can be stored in a second portion of the crypto-state database 1010. In at least one embodiment, the routing hash is three bits, resulting in eight crypto-state entries for eight request paths and eight crypto-state entries for the corresponding eight response paths. The crypto-state database 1010 and key database 1006 allow a single key to be used for different paths/routes between source and destination devices while providing unique security associations for each cryptographic ordered flow.

In at least one embodiment, the replay state database 1002, key database 1006, and entry crypto-state database 1010 can operate with the following parameters: i) a number of flows is approximately 1K; ii) a number of keys for transmit (Tx keys) is equal to the number of flows divided by 16; iii) the number of keys for receive (Rx keys) is equal to the TX keys times 2; iv) the number of flow map entries is equal to the number of flows divided by 16; v) the flow map width can be equal to Log 2 of the number of flow map entries (e.g., 28 bits); vi) crypto-state width is equal to 96 bits; vii) key width is equal to 32 B.

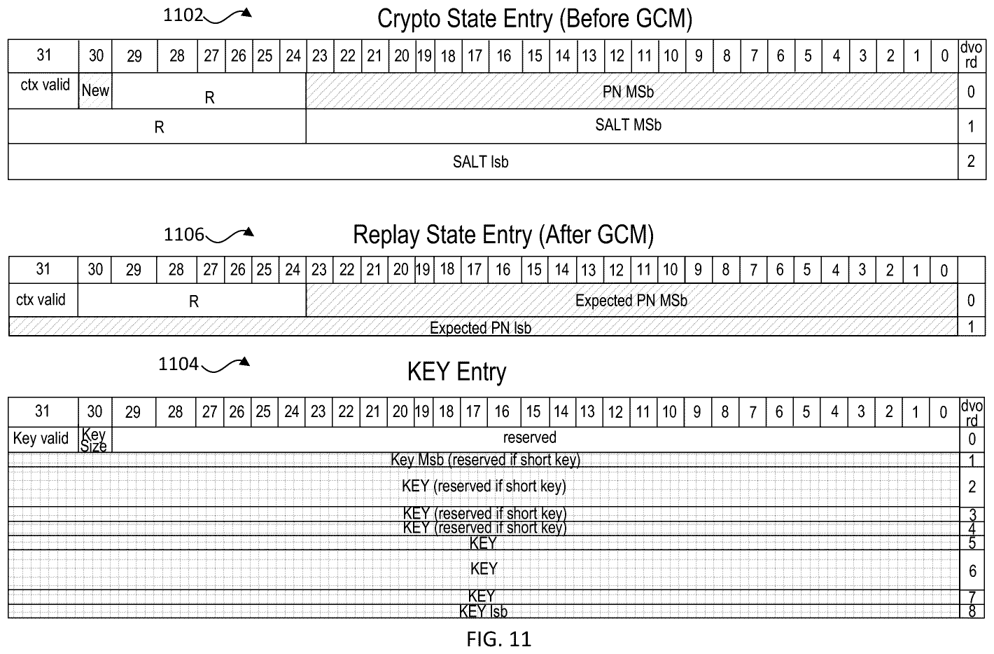

FIG. 11 illustrates an example crypto-state entry 1102, an example key entry 1104, and an example replay state entry 1106 according to various embodiments. As illustrated in FIG. 11, the crypto-state entry 1102 includes a packet number and a cryptographic salt. The key entry 1104 includes a key valid bit, a key size bit, a key epoch bit, and a key. The replay state entry 1106 includes an expected packet number, as described above. In at least one embodiment, the DCOF from the packet is a pointer used to identify the crypto-state entry 1012 (e.g., PTR=PKT.NVSECTAG.DcoFlow), and the DCF and key epoch are used for a pointer to identify the key entry 804 (e.g., PTR={DCF,Pkt.KeyEpoch}). The DCOF from the packet is a pointer used to identify a replay state entry (e.g., PTR=PKT.NVSECTAG.DcoFlow). The state entry number for the crypto-state entry 1102 and replay state entry 1106 equals the number of flows. The key entry number is the number of flows divided by eight (e.g., Key entry Num=Num of Flows/8).

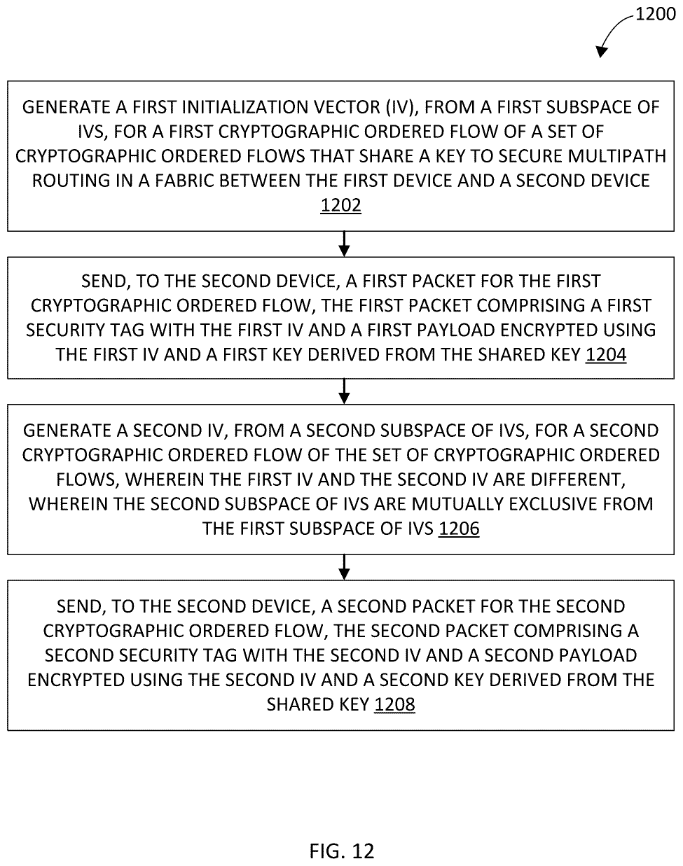

FIG. 12 is a method 1200 of operating a first device for native link encryption according to at least one embodiment. The method 1200 can be performed by processing logic comprising hardware, software, firmware, or any combination thereof. In at least one embodiment, method 1200 is performed by the first GPU 102, second GPU 104, or third GPU 106 of FIG. 1A or FIG. 1B. In at least one embodiment, the method 1200 is performed by GPU 500 of FIG. 5. In at least one embodiment, the method 1200 is performed by transmit pipeline 600 of FIG. 6.

Referring to FIG. 12, the method 1200 begins with the processing logic generating a first IV, from a first subspace of IVs, for a first cryptographic ordered flow of a set of cryptographic ordered flows that share a key to secure multipath routing in a fabric between the first device and a second device (block 1202). At block 1204, processing logic sends, to the second device, a first packet for the first cryptographic ordered flow, the first packet comprising a first security tag with the first IV and a first payload encrypted using the first IV and a first key derived from the shared key. At block 1206, processing logic generates a second IV, from a second subspace of IVs, for a second cryptographic ordered flow of the set of cryptographic ordered flows. The first IV and the second IV are different. The second subspace of IVs is mutually exclusive from the first subspace of IVs. At block 1208, processing logic, to the second device, a second packet for the second cryptographic ordered flow, the second packet comprising a second security tag with the second IV and a second payload encrypted using the second IV and a second key derived from the shared key.

In a further embodiment, the first IV can include i) a first SA index associated with the first device, ii) a second SA index associated with the second device, iii) a first path identifier of a first path of the multipath routing in the fabric between the first device and the second device, and iv) a first packet number (PN) associated with the first cryptographic ordered flow. The second IV can include i) a third SA index associated with the first device, ii) a fourth SA index associated with the second device, iii) a second identifier of the second cryptographic ordered flow, and iv) a second PN associated with the second cryptographic ordered flow. In at least one embodiment, the first cryptographic ordered flow is identified with a first security association having the first SA index, the second SA index, and the first path identifier. The second cryptographic ordered flow can be identified with a second security association having the first SA index, the second SA index, and the second path identifier.

In a further embodiment, the first security association further includes a first pipeline identifier, and the second security association further includes a second pipeline identifier.

In a further embodiment, the processing logic generates, using a first PSN and a first cryptographic salt, a first cryptographic state for the first PN. The processing logic can generate, using a second PSN and a second cryptographic salt, a second cryptographic state for the second PN.

In a further embodiment, the processing logic can store a first table. Each entry of the first table can store the first SA index, and the second SA index and is indexed by a device identifier. The processing logic can store a second table. Each entry of the second table can store a packet number (PN) and a cryptographic salt corresponding to one cryptographic ordered flow of the set of cryptographic ordered flows. The processing logic can store a third table. Each entry of the third table can store a shared key and a key index for key rotation.

In at least one embodiment, the first security tag is authenticated. In at least one embodiment, the first packet further includes a first authentication tag. In another embodiment, the second security tag is authenticated. In another embodiment, the second packet further includes a second authentication tag.

In at least one embodiment, the first packet includes a first LRH with a first identifier of the first device, a second identifier of the second device, and a pipeline identifier that identifies a pipeline at the first device. In at least one embodiment, the second packet includes a second LRH with the first identifier, the second identifier, and a pipeline identifier that identifies a pipeline at the first device.

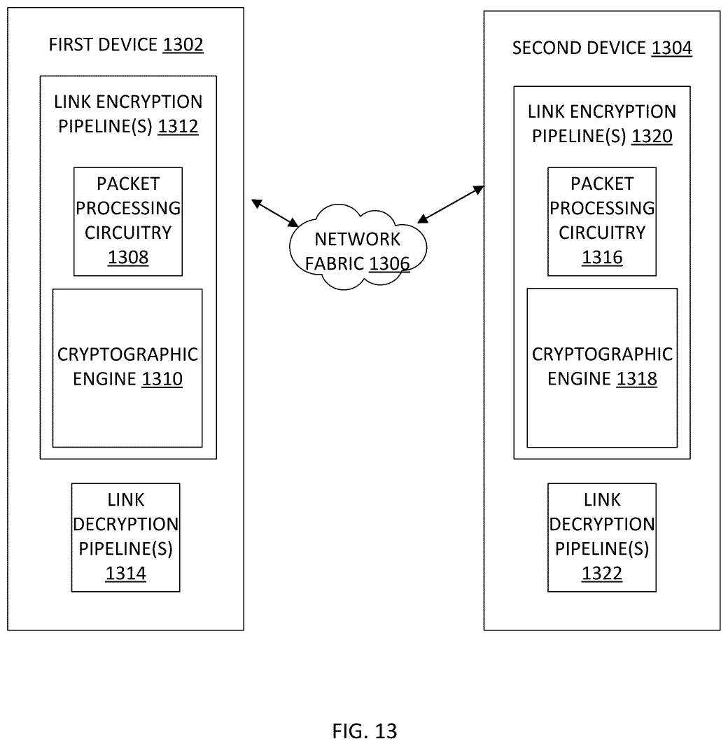

FIG. 13 is a block diagram of link encryption and decryption over multiple paths of a network fabric 1306 between a first device 1302 and a second device 1304 according to at least one embodiment. The first device 1302 includes packet processing circuitry 1308 and a cryptographic engine 1310 coupled to the packet processing circuitry 1308. The packet processing circuitry 1308 can generate IVs and packets to send to the second device 1304 over multiple paths. The cryptographic engine 1310 can encrypt the packets using a key and an IV. The cryptographic engine 1310 can receive and decrypt packets using a key and an IV. In at least one embodiment, the cryptographic engine 1310 can encrypt and decrypt payloads using the Advanced Encryption Standard with Galois Counter Mode (AES-GCM) block cipher mode to provide authenticated encryption and data integrity of the packets.

In at least one embodiment, the first device 1302 includes one or more link encryption pipeline(s) 1312 and one or more link decryption pipeline(s) 1314. Each of the link encryption pipeline(s) 1312 can include the packet processing circuitry 1308 and cryptographic engine 1310 for encrypting packets. Similarly, the link decryption pipeline(s) 1314 can include packet processing circuitry and a cryptographic engine for decrypting packets.

In at least one embodiment, the second device 1304 includes packet processing circuitry 1316 and a cryptographic engine 1318 coupled to the packet processing circuitry 1316. The packet processing circuitry 1316 can generate IVs and packets to send to the first device 1302 over multiple paths. The cryptographic engine 1318 can encrypt the packets using a key and an IV. The cryptographic engine 1318 can receive and decrypt packets using a key and an IV. In at least one embodiment, the second device 1304 includes one or more link encryption pipeline(s) 1320 and one or more link decryption pipeline(s) 1322. Each of the link encryption pipeline(s) 1320 can include the packet processing circuitry 1316 and cryptographic engine 1318 for encrypting packets. Similarly, the link decryption pipeline(s) 1322 can include packet processing circuitry and a cryptographic engine for decrypting packets.

In at least one embodiment, the packet processing circuitry 1308 can generate a first IV, from a first subspace of IVs, for a first cryptographic ordered flow of a set of cryptographic ordered flows that share a key to secure multipath routing in a fabric between the first device and a second device. The packet processing circuitry 1308 can send to the second device 1304 a first packet for the first cryptographic ordered flow. The cryptographic engine 1310 (e.g., link encryption pipeline(s) 1312) can encrypt the first packet. The first packet includes a first security tag with the first IV and a first payload encrypted by the cryptographic engine 1310 using the first IV and a first key derived from the shared key. The cryptographic engine 1310 can generate a second IV, from a second subspace of IVs, for a second cryptographic ordered flow of the set of cryptographic ordered flows. The first IV and the second IV are different, and the second subspace of IVs is mutually exclusive from the first subspace of IVs. The cryptographic engine 1310 can encrypt the second packet. The packet processing circuitry 1308 can send to the second device 1304 the second packet for the second cryptographic ordered flow. The second packet includes a second security tag with the second IV and a second payload encrypted by the cryptographic engine 1310 (e.g., link encryption pipeline(s) 1312) using the second IV and a second key derived from the shared key.

In at least one embodiment, the packet processing circuitry 1308 can generate the first packet and the first security tag. The cryptographic engine 1310 can encrypt the first payload using the first IV and the first key. The packet processing circuitry 1308 can generate the second packet and the second security tag. The cryptographic engine 1310 can encrypt the second payload using the second IV and the second key.

In at least one embodiment, a first link encryption pipeline includes the packet processing circuitry 1308 and the cryptographic engine 1310, and a second link encryption pipeline includes second packet processing circuitry and a second cryptographic engine (not illustrated in FIG. 13). In at least one embodiment, the second packet processing circuitry can generate a third IV for a third cryptographic ordered flow of a second set of cryptographic ordered flows that share a third key to secure multipath routing in the fabric between the first device and a third device (not illustrated in FIG. 13). The shared third key is different from the shared key. The second processing circuitry can send, to the third device, a third packet for the third cryptographic ordered flow. The third packet includes a third security tag with the third IV and a third payload encrypted by the second cryptographic engine using the third IV and a fourth key. The fourth key can be derived from the shared third key. The second packet processing circuitry can generate a fourth IV for a fourth cryptographic ordered flow of the second set of cryptographic ordered flows. The fourth IV and the third IV are different. The second packet processing circuitry can send, to the third device, a fourth packet for the fourth cryptographic ordered flow. The fourth packet includes a fourth security tag with the fourth IV, a fourth payload encrypted by the second cryptographic engine using the fourth IV, and a fifth key derived from the shared third key.

In a further embodiment, a first port can include the first link encryption pipeline and the second link encryption pipeline. In a further embodiment, a second port can include a third link encryption pipeline and a fourth link encryption pipeline. Similarly, the ports can have link decryption pipelines.

In at least one embodiment, the packet processing circuitry 1308 generates the first IV to include i) a first SA index associated with the first device, ii) a second SA index associated with the second device, iii) a first path identifier of a first path of the multipath routing in the fabric between the first device and the second device, and iv) a first PN associated with the first cryptographic ordered flow. The packet processing circuitry 1308 can generate the second IV to include i) a third SA index associated with the first device, ii) a fourth SA index associated with the second device, iii) a second identifier of the second cryptographic ordered flow, and iv) a second PN associated with the second cryptographic ordered flow. In at least one embodiment, the first cryptographic ordered flow is identified with a first security association comprising the first SA index, the second SA index, and the first path identifier. The second cryptographic ordered flow can be identified with a second security association comprising the first SA index, the second SA index, and the second path identifier.

In at least one embodiment, the first security tag is authenticated. The first packet can include a first authentication tag. The second security tag can be authenticated. The second packet can include a second authentication tag.

In at least one embodiment, the first device 1302 is at least one of a GPU, a CPU, a DPU, a switch (e.g., the NVLINK® switch), a rack switch, a scalable link interface (SLI), a link interface, or a NIC. In at least one embodiment, the second device 1304 is a GPU, a CPU, a DPU, or a NIC. In at least one embodiment, the first device 1302 is the first GPU, and the second device 1304 is the second GPU. The first GPU and the second GPU are coupled via the network fabric 1306. The first GPU (or the second GPU) can perform the operations described above.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if something is intervening. Recitations of ranges of values herein are merely intended to serve as a shorthand method of referring individually to each separate value falling within the range unless otherwise indicated herein, and each separate value is incorporated into the specification as if it were individually recited herein. In at least one embodiment, the use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two but can be more when indicated explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more individual non-transitory storage media of multiple non-transitory computer-readable storage media lack all of the code while multiple non-transitory computer-readable storage media collectively store all of the code. In at least one embodiment, executable instructions are executed such that different processors execute different instructions.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, the terms “coupled” and “connected,” and their derivatives may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes for continuously or intermittently carrying out instructions in sequence or parallel. In at least one embodiment, the terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in various ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality and are intended to be within the scope of this disclosure. Furthermore, although specific distributions of responsibilities may be defined above for purposes of description, various functions and responsibilities might be distributed and divided in different ways, depending on the circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A method of operating a first device, the method comprising:
generating a first initialization vector (IV), from a first subspace of IVs, for a first cryptographic ordered flow of a plurality of cryptographic ordered flows that share a key to secure multipath routing in a fabric between the first device and a second device;
sending, to the second device, a first packet for the first cryptographic ordered flow, the first packet comprising a first security tag with the first IV and a first payload encrypted using the first IV and a first key derived from the shared key;
generating a second IV, from a second subspace of IVs, for a second cryptographic ordered flow of the plurality of cryptographic ordered flows, wherein the first IV and the second IV are different, wherein the second subspace of IVs are mutually exclusive from the first subspace of IVs, and
sending, to the second device, a second packet for the second cryptographic ordered flow, the second packet comprising a second security tag with the second IV and a second payload encrypted using the second IV and a second key derived from the shared key.

2. The method of claim 1, wherein:
the first IV comprises i) a first security association (SA) index associated with the first device, ii) a second SA index associated with the second device, iii) a first path identifier of a first path of the multipath routing in the fabric between the first device and the second device, and iv) a first packet number (PN) associated with the first cryptographic ordered flow; and
the second IV comprises i) a third SA index associated with the first device, ii) a fourth SA index associated with the second device, iii) a second identifier of the second cryptographic ordered flow, and iv) a second PN associated with the second cryptographic ordered flow;
the first cryptographic ordered flow is identified with a first security association comprising the first SA index, the second SA index, and the first path identifier; and
the second cryptographic ordered flow is identified with a second security association comprising the first SA index, the second SA index, and the second path identifier.

3. The method of claim 2, wherein:
the first security association further comprises a first pipeline identifier; and
the second security association further comprises a second pipeline identifier.

4. The method of claim 2, further comprising:
generating, using a first packet sequence (PSN) and a first cryptographic salt, a first cryptographic state for the first PN; and
generating, using a second PSN and a second cryptographic salt, a second cryptographic state for the second PN.

5. The method of claim 2, further comprising:
storing a first table, each entry of the first table to store the first SA index, the second SA index and is indexed by a device identifier;
storing a second table, each entry of the second table to store a packet number (PN) and a cryptographic salt corresponding to one of the plurality of cryptographic ordered flows; and
storing a third table, each entry of the third table to store a shared key and a key index for key rotation.

6. The method of claim 1, wherein the first security tag is authenticated, and wherein the first packet further comprises a first authentication tag.

7. The method of claim 6, wherein the first packet comprises a first local route header (LRH) comprising:
a first identifier of the first device;
a second identifier of the second device; and
a pipeline identifier that identifies a pipeline at the first device.

8. A first device comprising:
packet processing circuitry; and
a cryptographic engine coupled to the packet processing circuitry, wherein the packet processing circuitry is to:
generate a first initialization vector (IV), from a first subspace of IVs, for a first cryptographic ordered flow of a plurality of cryptographic ordered flows that share a key to secure multipath routing in a fabric between the first device and a second device;
send, to the second device, a first packet for the first cryptographic ordered flow, the first packet comprising a first security tag with the first IV and a first payload encrypted by the cryptographic engine using the first IV and a first key derived from the shared key;
generate a second IV, from a second subspace of IVs, for a second cryptographic ordered flow of the plurality of cryptographic ordered flows, wherein the first IV and the second IV are different, wherein the second subspace of IVs are mutually exclusive from the first subspace of IVs; and
send, to the second device, a second packet for the second cryptographic ordered flow, the second packet comprising a second security tag with the second IV and a second payload encrypted by the cryptographic engine using the second IV and a second key derived from the shared key.

9. The first device of claim 8, wherein:
the packet processing circuitry is to generate the first packet and the first security tag;
the cryptographic engine is to encrypt the first payload using the first IV and the first key;
the packet processing circuitry is to generate the second packet and the second security tag; and
the cryptographic engine is to encrypt the second payload using the second IV and the second key.

10. The first device of claim 8, further comprising:
a first link encryption pipeline comprising the packet processing circuitry and the cryptographic engine; and
a second link encryption pipeline comprising second packet processing circuitry and a second cryptographic engine.

11. The first device of claim 10, further comprising:
a first port comprising the first link encryption pipeline and the second link encryption pipeline; and
a second port comprising a third link encryption pipeline and a fourth link encryption pipeline.

12. The first device of claim 10, wherein the second packet processing circuitry is to:
generate a third IV for a third cryptographic ordered flow of a second plurality of cryptographic ordered flows that share a third key to secure multipath routing in the fabric between the first device and a third device, wherein the shared third key is different from the shared key;
send, to the third device, a third packet for the third cryptographic ordered flow, the third packet comprising a third security tag with the third IV and a third payload encrypted by the second cryptographic engine using the third IV and a fourth key derived from the shared third key;
generate a fourth IV for a fourth cryptographic ordered flow of the second plurality of cryptographic ordered flows, wherein the fourth IV, and the third IV are different; and
send, to the third device, a fourth packet for the fourth cryptographic ordered flow, the fourth packet comprising a fourth security tag with the fourth IV and a fourth payload encrypted by the second cryptographic engine using the fourth IV and a fifth key derived from the shared third key.

13. The first device of claim 8, wherein the cryptographic engine is to encrypt the first payload using the Advanced Encryption Standard with Galois Counter Mode (AES-GCM) block cipher mode to provide authenticated encryption and data integrity of the first packet.

14. The first device of claim 8, wherein:
the first IV comprises i) a first security association (SA) index associated with the first device, ii) a second SA index associated with the second device, iii) a first path identifier of a first path of the multipath routing in the fabric between the first device and the second device, and IV) a first packet number (PN) associated with the first cryptographic ordered flow; and
the second IV comprises i) a third SA index associated with the first device, ii) a fourth SA index associated with the second device, iii) a second identifier of the second cryptographic ordered flow, and IV) a second PN associated with the second cryptographic ordered flow;
the first cryptographic ordered flow is identified with a first security association comprising the first SA index, the second SA index, and the first path identifier; and
the second cryptographic ordered flow is identified with a second security association comprising the first SA index, the second SA index, and the second path identifier.

15. The first device of claim 14, wherein:
the first security association further comprises a first pipeline identifier; and
the second security association further comprises a second pipeline identifier.

16. The first device of claim 8, wherein the first security tag is authenticated, and wherein the first packet further comprises a first authentication tag.

17. A computing system comprising:
a network fabric;
a first graphics processing unit (GPU); and
a second GPU coupled to the first GPU via the network fabric, wherein the first GPU is to:
generate a first initialization vector (IV), from a first subspace of IVs, for a first cryptographic ordered flow of a plurality of cryptographic ordered flows that share a key to secure multipath routing in a fabric between the first device and a second device;
send, to the second device, a first packet for the first cryptographic ordered flow, the first packet comprising a first security tag with the first IV and a first payload encrypted by the cryptographic engine using the first IV and a first key derived from the shared key;
generate a second IV, from a second subspace of IVs, for a second cryptographic ordered flow of the plurality of cryptographic ordered flows, wherein the first IV and the second IV are different, wherein the second subspace of IVs are mutually exclusive from the first subspace of IVs; and
send, to the second device, a second packet for the second cryptographic ordered flow, the second packet comprising a second security tag with the second IV and a second payload encrypted by the cryptographic engine using the second IV and a second key derived from the shared key.

18. The computing system of claim 17, further comprising:
a third GPU coupled to the first GPU and the second GPU via the network fabric, wherein the first GPU is further to:
generate a third IV for a third cryptographic ordered flow of a second plurality of cryptographic ordered flows that share a third key to secure multipath routing in the network fabric between the first GPU and the third GPU, wherein the shared third key is different from the shared key;
send, to the third GPU, a third packet for the third cryptographic ordered flow, the third packet comprising a third security tag with the third IV and a third payload encrypted using the third IV and a fourth key derived from the shared third key;
generate a fourth IV for a fourth cryptographic ordered flow of the second plurality of cryptographic ordered flows, wherein the fourth IV and the third IV are different; and
send, to the second GPU, a fourth packet for the fourth cryptographic ordered flow, the fourth packet comprising a fourth security tag with the fourth IV and a fourth payload encrypted using the fourth IV and a fifth key derived from the shared third key.

19. The computing system of claim 17, wherein:
the first IV comprises i) a first security association (SA) index associated with the first device, ii) a second SA index associated with the second device, iii) a first path identifier of a first path of the multipath routing in the fabric between the first device and the second device, and IV) a first packet number (PN) associated with the first cryptographic ordered flow; and
the second IV comprises i) a third SA index associated with the first device, ii) a fourth SA index associated with the second device, iii) a second identifier of the second cryptographic ordered flow, and IV) a second PN associated with the second cryptographic ordered flow;
the first cryptographic ordered flow is identified with a first security association comprising the first SA index, the second SA index, and the first path identifier; and
the second cryptographic ordered flow is identified with a second security association comprising the first SA index, the second SA index, and the second path identifier.

20. The computing system of claim 19, wherein:
the first security association further comprises a first pipeline identifier; and
the second security association further comprises a second pipeline identifier.

21. The computing system of claim 17, wherein the first security tag is authenticated, and wherein the first packet further comprises a first authentication tag.
